(19) United States
(12) Patent Application Publication
(10) Pub. No.: US 2022/0269701 A1
(43) Pub. Date: Aug. 25, 2022

(54) METHOD, APPARATUS, SYSTEM AND STORAGE MEDIUM FOR DATA VISUALIZATION

(71) Applicant: BOE TECHNOLOGY GROUP CO., LTD., Beijing (CN)

(72) Inventors: Hongda YU, Beijing (CN); Di WU, Beijing (CN); Haijun FAN, Beijing (CN); Dahai HOU, Beijing (CN); Chu CHU, Beijing (CN)

(21) Appl. No.: 17/508,354

(22) Filed: Oct. 22, 2021

(30) Foreign Application Priority Data
Feb. 23, 2021 (CN) 202110204488.X

(51) Int. Cl. G06F 16/28; G06F 16/23; G06F 16/2455

(52) U.S. Cl. CPC G06F 16/287; G06F 16/288; G06F 16/2358; G06F 16/24556

(57) ABSTRACT

A data visualization method is disclosed, including receiving business data and classifying the business data according to a business type associated with the business data so as to form multiple sets of target data, processing at least one set of the multiple sets of target data to obtain update data for an interactive interface, the interactive interface corresponding to the business type of the at least one set of target data and configured to display the at least one set of target data; rendering the interactive interface based on the update data to update content of the interactive interface. Thereby, isolation of data of different business types and linkage of data of the same business type are achieved, which improves the efficiency of visualized presentation of data.

### RELATED APPLICATION

This disclosure claims the priority of Chinese patent application No. 202110204488.X filed on Feb. 23, 2021, the entire disclosure of which is incorporated herein by reference.

### FIELD

This disclosure relates to the technical field of data visualization, and in particular to a method, apparatus, system and storage medium for data visualization.

### BACKGROUND

With the development of the Internet of Things (JOT) technology, we have entered a new era of “Internet of Everything”. More and more smart devices (such as networkable cameras, networkable sensors and detection devices, etc.) have been applied in each and every aspect of life and production, providing us with real-time and efficient services.

A park generally comprises sites such as buildings, park roads, meeting rooms, parking lots, office areas, exhibition halls, etc. characterized in a large area, many buildings, complex terrain, and various types/a lot of equipment to be monitored. Currently, monitoring service of the park may be achieved by arranging smart devices therein and collecting related park data via the smart devices. Although the smart devices can collect a huge amount and a wide variety of park data, there is no solution for effective organization and visualized presentation of these data in related arts. Therefore, how to improve the effect of visualized presentation of data has become an urgent technical problem to be solved.

### SUMMARY

In one embodiment of this disclosure, a data visualization method is provided. The method comprises: receiving business data and classifying the business data according to a business type associated with the business data so as to form multiple sets of target data; processing at least one of the multiple sets of target data to obtain update data for an interactive interface, the interactive interface corresponding to the business type of the at least one set of target data and configured to display the at least one set of target data; and rendering the interactive interface based on the update data to realize content update of the interactive interface.

Optionally, the at least one set of target data is associated with a target display window in the interactive interface. Processing at least one of the multiple sets of target data to obtain update data for an interactive interface comprises: processing the at least one set of target data to obtain update data for the target display window in the interactive interface, and said rendering the interactive interface based on the update data comprises assigning the update data to the target display window to refresh the target display window.

Optionally, processing at least one of the multiple sets of target data to obtain update data for an interactive interface comprises: analyzing target data in the at least one set of target data to determine a related data source for the target data, acquiring further data related to the target data from the related data source, and obtaining update data for the interactive interface by integrating the target data and acquired further data.

Optionally, acquiring further data related to the target data from the related data source comprises: in response to determination of the related data source, linking the related data source by utilizing dependency injection through a proxy, and receiving further data injected from the related data source through the proxy so as to acquire the further data related to the target data.

Optionally, the interactive interface displays a 2D user interface and a 3D model, and said processing at least one of the multiple sets of target data to obtain update data for an interactive interface comprises: obtaining 2D data for updating the 2D user interface and 3D data for updating the 3D model.

Optionally, rendering the interactive interface based on the update data comprises: batch-rendering objects of a same material in the 3D data; and/or merging multiple pictures in the 2D data into one picture before rendering; and/or cropping an object outside the field of view in the 3D data before rendering.

Optionally, a mesh is created and assigned to a 2D object during building of the 3D model, the mesh corresponding to a shape of a specified display region of the 2D user interface. Rendering the interactive interface based on the update data comprises: extracting 2D data from the update data as update data for the 2D object; and rendering the specified display region based on the 2D data.

Optionally, the business data is generated based on monitoring data for the environment produced by a smart device. The business type is divided according to characteristics of the monitoring data. The characteristics comprise at least one of: monitoring objects for which the monitoring data is generated and purposes of the monitoring data.

Optionally, receiving business data comprises: determining a data type of received business data; in response to a determination that the received business data is data of an indirect use type, using the received business data as primary business data, and extracting index information from the primary business data; accessing a related data source according to the index information to acquire secondary business data; and aggregating the primary business data and the secondary business data to generate aggregated business data.

In another aspect of this disclosure, an electronic device is provided. The electronic device comprises a memory, a processor and a computer program stored on the memory and executable on the processor. The processor can implement the method according to the embodiments of this disclosure when executing the program.

In yet another embodiment of this disclosure, a non-transitory computer-readable storage medium is provided. The computer-readable storage medium has a computer program stored thereon. The computer program, when executed by a processor, can implement the method according to the embodiments of this disclosure.

In still another embodiment of this disclosure, an apparatus for data visualization is provided. The apparatus comprises: a dispatcher unit configured to receive business data and classify the business data according to a business type associated with the business data so as to form multiple sets of target data; a data processing unit configured to receive target data from the dispatcher unit, and process at least one of the multiple sets of target data to obtain update data for an interactive interface, the interactive interface corresponding to the business type of the at least one set of target data and configured to display the at least one set of target data; and a rendering unit configured to render the interactive interface based on the update data to update content of the interactive interface.

In still another embodiment of this disclosure, a system for data visualization is provided. The system comprises: a smart device for collecting monitoring data; a server for receiving the monitoring data and generating business data based on the monitoring data; and an electronic device or an apparatus for data visualization according to the embodiments of this disclosure.

### BRIEF DESCRIPTION OF DRAWINGS

The embodiments of this disclosure will only be described by way of examples with reference to the drawings, wherein:

FIG. 1 is a schematic view of an exemplary implementation of a system according to an embodiment of this disclosure;

FIG. 2 is an exemplary flow chart of a method according to an embodiment of this disclosure;

FIG. 3 is a screen shot of an exemplary interface according to an embodiment of this disclosure;

FIG. 4 is an exemplary flow chart of a method for obtaining update data according to an embodiment of this disclosure;

FIG. 5 is a further screen shot of an exemplary interface according to an embodiment of this disclosure;

FIG. 6a is a schematic view showing the processing of pictures during picture rendering in related arts;

FIG. 6b is a schematic view showing the processing of pictures during picture rendering according to an embodiment of this disclosure;

FIG. 7 is a still further screen shot of an exemplary interface according to an embodiment of this disclosure;

FIG. 8 is a schematic structure view of an apparatus according to an embodiment of this disclosure;

FIG. 9 shows the display effect of warning business data according to an embodiment of this disclosure;

FIG. 10 is a schematic structure view of a computing device according to an embodiment of this disclosure.

### DETAILED DESCRIPTION OF EMBODIMENTS

In the description below, for explanatory purposes instead of limiting purposes, some specified details of the disclosed embodiments are stated so as to describe the technical solutions in the embodiments of this disclosure in a clear and complete manner. However, those skilled in the art should easily understand that, without prominently departing from the scope and spirit of this disclosure, this disclosure may be implemented by further embodiments, and these further embodiments do not exactly conform to the details herein.

Firstly, the term “and/or” herein is only a related relationship describing related objects, which means there may be three relations, e.g., A and/or B may mean: A or B or both A and B. Also, at least one of A or B and/or the like generally means A or B or both A and B. Besides, the symbol “/” herein generally means that the related objects before and after it have an “or” relation.

In related arts, since there is a huge amount of and a wide variety of park data, no solution is available for effective organization and visualized presentation of these data, which affects the effect of visualized presentation of the park data.

To this end, in embodiments of this disclosure, a solution for data visualization is provided for improving the effect of visualized presentation of data. In the solution according to embodiments of this disclosure, by classifying business data into different target data sets based on a business type, and processing at least one set of target data to obtain the updated data of an interactive interface corresponding to the business type of the set of target data, isolation of business data of different business types and linkage of business data of the same business type are achieved during the visualized presentation of data. According to embodiments of this disclosure, massive business data is divided into smaller target data sets according to the business type, and the interactive interface is arranged to correspond to different business types, so the business data is organized in an orderly and structured way. As such, linkage of target data in the same target data set can be achieved, which improves the effect of visualized presentation of business data. Meanwhile, this also reduces the amount of data processing involved in the update of the interactive interface, promotes the speed of data processing and improves the efficiency of visualized presentation of business data.

Prior to detailed introduction to the embodiments of the present application, some related concepts will be explained first.

Modeling technology may refer to the technology of manual modeling based on GIS data, CAD two-dimensional vector diagram and other architectural data using modeling software such as 3dsMax, AutoCAD, etc., for software system rendering and display.

Internet of Things (IOT) technology may refer to the technology of enabling all ordinary physical objects that can be independently addressed to form an interconnected network based on information carriers such as the Internet/LAN, traditional telecommunication networks, etc.

Artificial intelligence (AI) may refer to the technology of studying and developing theories, methods, techniques and application systems for simulating, extending and expanding human intelligence.

Data visualization may refer to visual presentation of data.

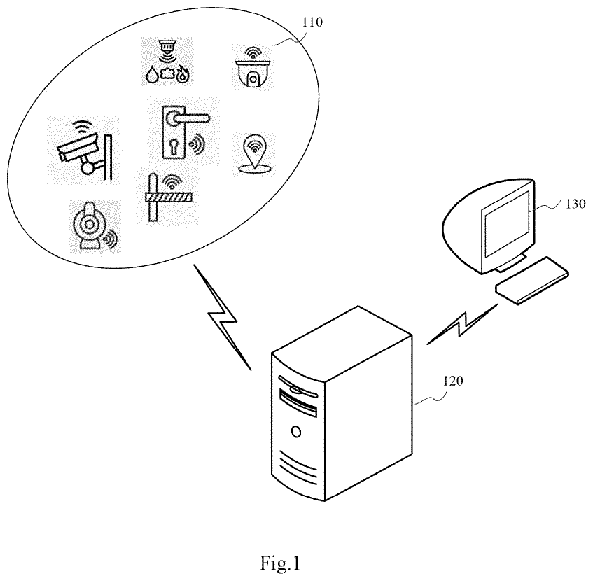

FIG. 1 shows a schematic view of an exemplary implementation of a system according to embodiments of this disclosure. The system may be applied in environments such as schools, hospitals, shopping malls, stations, airports, parks and so on. As shown in FIG. 1, the system may comprise a smart device 110, a server 120 and an electronic device 130. The smart device 110 is configured to collect monitoring data. The server 120 is configured to acquire the monitoring data and generate business data based on the monitoring data. The electronic device 130 is configured to visualize the business data so as to display it to an end user.

The smart device 110 may be arranged in multiple positions of an environment (e.g., a park) and configured to collect monitoring data related to the environment. The smart device 110 may comprise an IOT device. The IOT device comprises any device capable of participating in and/or communicating with an IOT system or network, for example, equipment and apparatuses associated with vehicles (such as navigation systems, autonomous driving systems, etc.), equipment, apparatuses and/or infrastructures associated with industrial manufacturing and production, etc., and various apparatuses in smart entertainment systems (such as televisions, audio systems, electronic game systems), smart home or office systems, security systems (such as monitoring systems) and e-commerce systems, etc. For instance, the smart device may be a camera, a sensor, a positioning device or the like.

The smart device 110 may be configured to monitor different types of objects, e.g., sites, people or events, etc. Exemplarily, in the scenario of a park, sites may comprise for example buildings, park roads, meeting rooms, parking lots, office areas, exhibition halls, etc., and people may comprise staff members of the park (such as gatekeepers, cleaners, workers, managers, etc.) and visitors, etc., and events may comprise warning prompts and message notifications related to equipment (such as air conditioners, elevators, etc.) and/or pipelines (such as power supply, water supply, gas supply pipelines) of the park.

The monitoring data collected by the smart device 110 may comprise any data related to a monitored object. Optionally, the monitoring data may comprise image or video data captured by a camera, sensing data sensed by a sensor, positioning data determined by a positioning device and so on. For example, the monitoring data may be a real-time picture of the monitored object (e.g., a site and/or a person) captured by a camera, a running index (e.g., temperature, humidity, smoke density, remaining battery power, etc.) of the monitored object (e.g., equipment/building) sensed by a sensor, and a position (e.g., positioning information, etc.) of the monitored object provided by a positioning device. The monitoring data may be used, for example according to a predefined plan, for various purposes such as reflecting park situation, performing park management, performing asset management, performing office space management, implementing smart security and convenient transportation.

In some embodiments, the smart device 110 may act as a publisher by using a message transmission protocol of a publish/subscribe model, so as to transmit the monitoring data to the server 120, thereby gathering together the monitoring data to the server. For example, the smart device may use a lightweight proxy-based publish/subscribe message queue transmission protocol MQTT (Message Queuing Telemetry Transport) to transmit monitoring data. The smart device may send the monitoring data to the server periodically. Alternatively or additionally, when the collected monitoring data is changed, the smart device may also send the changed monitoring data to the server.

The server 120 may receive or acquire monitoring data from multiple smart devices 110. The server 120 may be an independent physical server, or a server cluster or a distributed system consisting of a plurality of physical servers. The server 120 may be a local server, or a cloud platform server providing basic cloud computing services such as cloud services, cloud databases, cloud computing, cloud functions, cloud storage, network services, cloud communications, middleware services, security services, and big data and artificial intelligence platforms, etc.

The server 120 may analyze the monitoring data in real time or near real time for example, and generate business data. The server may be configured to extract, convert and analyze the monitoring data from the smart device so as to generate corresponding business data. Optionally, the server may further clean the monitoring data so as to remove the interference of incorrect data on subsequent data. In some embodiments, the server may use AI (Artificial Intelligence) algorithms to analyze the monitoring data in real time, so as to generate business data. For example, in a scenario where the monitoring data is video data, the server may use AI algorithms to extract an object of interest (e.g., a person or a vehicle, etc.) from the video data, so as to perform identification, counting, occupancy status identification and/or real-time location tracking, etc.

In some embodiments, the server may generate different types of business data based on the monitored object for which the monitoring data is generated. For example, in the scenario of a park, based on the monitored object for which the monitoring data is generated being a site, a person or an event, the server may correspondingly generate site type business data related to sites, people type business data related to people or event type business data related to events and so on.

In an example, a positioning device and/or camera may be installed at a specified position of the monitored environment. The server may analyze the monitoring data from the positioning device and/or camera to generate business data related to people, including information about the real-time position of different people. In another example, a sensor may be installed on an equipment to be monitored in the park. The server may analyze the monitoring data from the sensor and obtain the state of the monitored equipment to generate business data related to events. For example, if the state of the equipment is abnormal, business data corresponding a warning prompt, or business data corresponding to a message notification, will be generated.

In some embodiments, the monitoring data may comprise multiple kinds of business information. The server may generate business data of different business types based on different business information comprised in the monitoring data.

For example, in a scenario of a meeting room monitored by a smart device, the server may analyze an occupancy status of the meeting room based on the monitoring data such as video data or image data collected by the smart device (e.g., a camera). The occupancy status may comprise: “idle”, “in use”, “reserved”, “overtime” and so on. The server may correspondingly generate site type business data indicating or notifying the current occupancy status of the meeting room based on the analysis result. Furthermore, the server may also analyze abnormal behaviors of participants in the meeting room based on the captured video or image of the meeting room, and generate event type business data corresponding to a warning prompt based on that.

For example, in a scenario of a parking lot monitored by a smart device, the server may analyze a current use status of each parking space in the parking lot based on the monitoring data such as video data or image data collected by the smart device (e.g., a camera). The current use status may comprise: “idle”, “in use” and so on. The server may correspondingly generate business data indicating or notifying the current use status of the parking lot based on the analysis result. Furthermore, the server may also analyze behaviors of abnormal use of parking spaces such as improper parking in a parking space and illegal occupation of special parking spaces, and generate business data corresponding to a warning prompt.

For example, in a scenario of a visitor monitored by a smart device, the server may analyze abnormal behaviors of a visitor (e.g., overstay, illegal intrusion into a forbidden zone, etc.) based on the monitoring data collected by the smart device (e.g., a camera). The server may generate business data corresponding to a warning prompt when it determines that the visitor has abnormal behaviors through analysis.

In some embodiments, the server 120 may use a publish/subscribe model to realize transfer of business data. For example, the server 120 may use MQTT to transmit business data.

The electronic device 130 may receive business data from the server and visualize the business data using a solution according to the embodiments of this disclosure so as to display it to the end user in a visualized way. Exemplarily, the electronic device 130 may comprise a mobile phone, a computer, a messaging device, a tablet device, a personal digital assistant and so on.

In an embodiment where the business data is transferred by using a publish/subscribe model, the electronic device 130 may act as a subscriber to subscribe to business data of interest from the server 120.

For instance, in a topic-based publish-subscribe model, the electronic device may subscribe to a desired topic. The server may push all message data published under the topic(s) subscribed by the electronic device to the electronic device.

For example, if the user wants to follow the parking state of a parking lot, he/she may subscribe to a topic of the parking lot from the server via the electronic device so as to acquire corresponding business data. If the user wants to follow the running state of an elevator, he/she may subscribe to a topic of the elevator from the server via the electronic device so as to acquire corresponding business data.

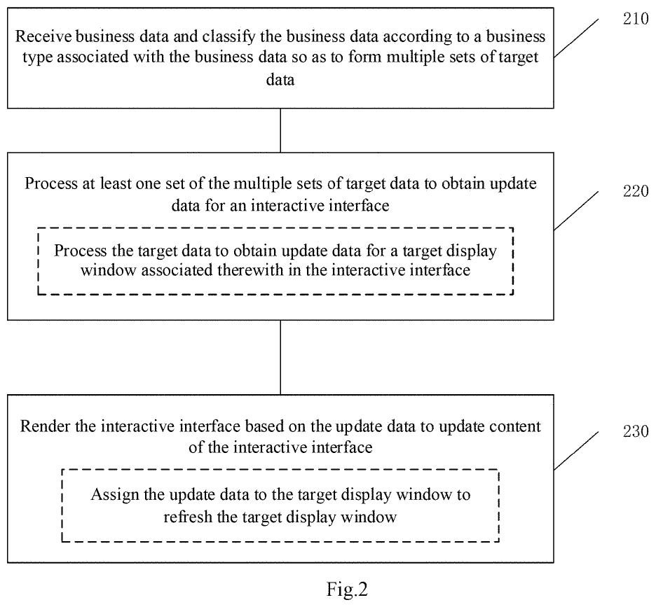

FIG. 2 shows a flow chart of a method according to an embodiment of this disclosure. The method may be implemented in an electronic device as shown in FIG. 1 or in an apparatus for data visualization according to the embodiments of this disclosure. The method comprises:

Step 210: receiving business data and classifying the business data according to a business type associated with the business data so as to form multiple sets of target data. Each set of target data has a corresponding business type.

The business data may be received from a server and generated based on the monitoring data produced by a smart device. Exemplarily, the business data may be generated by re-integrating monitoring information for a business purpose in one or more monitoring data. Additionally, other information known for the same business purpose may also be used in the re-integration. For example, for warning information, the server can form a complete piece of business data by combining a warning type (a forbidden zone intrusion type, an equipment damage warning type, etc.), warning time, a warning location, and other information for warning purposes, etc. contained in the monitoring data.

The business type of the business data may be divided according to characteristics of the monitoring data. In some embodiments, the business type may be divided according to monitored objects for which the monitoring data is generated. The monitored objects may comprise sites, people and events. Correspondingly, the business type may also be divided into a site type, a people type and an event type. Furthermore, depending on different sites, different people and different events, the business data may further be subdivided into more sub-business types.

For instance, different sites comprise: meeting rooms, parking lots, office areas, exhibition halls and so on. Correspondingly, the site type business data may comprise business data corresponding to meeting rooms, business data corresponding to parking lots, business data corresponding to office areas, business data corresponding to exhibition halls and so on. Different people comprise: visitors, staff members (such as gatekeepers, cleaners, workers, managers) and so on. Correspondingly, people type business data may comprise business data corresponding to visitors, business data corresponding to staff members and so on. Different events comprise: warning prompts, message notifications and so on. Correspondingly, event type business data may comprise business data corresponding to warning prompts, business data corresponding to message notifications and so on.

In some further embodiments, the business type may also be divided according to intended/predefined purposes of the monitoring data. For example, the monitoring data may be collected for reflecting park situation, performing park space management, performing asset management, performing office space management, implementing smart security and convenient transportation and so on.

For example, in order to reflect the park situation, monitoring data related to park warnings (a comprehensive display of various warning information in the park), overall park overview (the number of people, the number of vehicles), deployment monitoring (running state of various equipment), park work order state analysis (disposal rate, satisfaction), park energy efficiency analysis (power consumption, water consumption), park traffic analysis and so on may be collected. In order to perform park space management, monitoring data related to garbage overflow warnings, smoking warnings, building warnings, cleaning warnings, bicycle warnings and so on may be collected. In order to perform asset management, monitoring data related to equipment warnings, park asset utilization rate, important asset equipment analysis, equipment maintenance and operation work order state, equipment maintenance and operation work order response time and so on may be collected. In order to perform office space management, monitoring data related to real-time identification of personnel entering the office area, seating saturation analysis, vacant seating change trends, meeting room reservation information, meeting room popularity analysis, time-segmented meeting room utilization rate and so on may be collected. In order to implement smart security, monitoring data related to abnormal personnel warning information, warning event state statistics, warning trends, real-time state monitoring of non-resident personnel, state distribution of forbidden zones in the park may be collected. In order to implement convenient transportation, monitoring data related to vehicle abnormality warnings, parking lot vehicle record statistics on the day, park traffic analysis, remaining parking space detection, charging pile usage condition and so on may be collected.

It would be understood that a piece of business data (e.g., equipment warning information) may be associated with more than one business types (e.g., park situation, park space, asset management and smart security, etc.), and therefore be classified into more than one sets of target data according to an adopted business type classification rule.

It would be understood that the above division of business types is only exemplary instead of restrictive, and other division rules may also be set flexibly according to actual business needs and specific characteristics of a monitored environment.

The business data may be classified into respective business types according to business information contained in the business data.

In a scenario where the business type is divided according to monitored objects and then may include a site type, a people type and an event type for example, business data may be classified according to information identifying the monitored objects contained therein. Such information may be information identifying positions, information identifying people, information identifying events and so on.

For instance, when the business data contains position information, it may be classified as site type business data. The site type business data forms a target data set related to sites. Furthermore, the corresponding position of the business data may further be determined based on the position information, and then the business data may be classified based on its position into a sub-type of a certain site, such as a meeting room, an office area and so on. When the business data contains people identity information, it may be classified as people type business data. The people type business data forms a target data set related to people. When the business data contains warning identification information, it may be classified as event type business data. The event type business data forms a target data set related to events.

In a scenario where the business type is divided according to the intended/predefined purposes of the monitoring data, which may include smart security and convenient transportation for example, the business data may be classified according to information related to monitoring purposes contained therein. Such information may be information related to warnings, information related to counting of people or objects, information related to occupancy of space and so on.

For example, when the business data contains warning information from security equipment (such as access control systems, smoke sensors, cameras in forbidden zones, etc.) installed in the monitored environment, it may be classified as business data related to smart security. When the business data contains information related to vehicles (e.g., vehicle count in a parking lot, traffic volume on a road, number of charging piles occupied), it may be classified as business data related to convenient transportation.

Alternatively or additionally, in a scenario where the business data provided by the server has an indication of a corresponding business type, the business data may also be classified according to a business type tag (if any) contained in the business data. For example, the type of the business data may be determined according to a topic to which the subscription is made in the server. Exemplarily, when there is a topic of “warnings” in the server, business data obtained by subscribing to this topic may be classified as event type business data.

In some embodiments, the business data may be of different data types, for example, direct use type and indirect use type (also referred to as a type that needs to be re-applied and aggregated). Data of direct use type refers to data that can be used directly, e.g., in some scenarios, equipment abnormality warning information data can be used directly. Thereby, equipment abnormality warning information data can be directly pushed to a corresponding data processing unit for display. Data of indirect use type refers to data for which additional secondary business data is required to be applied and aggregated therewith. When business data is determined to be data of indirect use types, index information may be extracted from the business data, and an interface is invoked again according to the index information so as to acquire additional secondary business data containing more detailed information from the data source or other data sources. For example, in some scenarios, visitor abnormality warning information data may be considered unable to be used directly. Therefore, upon receipt of visitor abnormality warning information data, it is required to invoke an API (Application Programming Interface) again according to the warning position information contained in the data to acquire picture information from ambient smart devices/monitoring devices so as to obtain identification information of the visitor, and aggregate the picture information and the identification information to generate new business data. The new business data is pushed to a corresponding data processing unit for display. Exemplarily, the acquired picture information may be analyzed by using AI algorithm or other algorithms to obtain identification information of the visitor.

Optionally, data type of business data may be determined according to a data type classification rule before or after classification of the business data based on business types. The data type classification rule may either be common for all business types, or vary with different business types. For example, when the business type of the business data is park situation, the focus of a corresponding interactive interface will be an overview of the entire park. As such, display of warning information details for an individual warning may probably occupy regions for displaying other important business data in the park. Hence, for a park situation type, the visitor abnormality warning information data may be classified as data of a direct use type. As a result, the warning information data is directly used for displaying a brief summary of the warning information. When the business type of the business data is smart security, the focus of the corresponding interface is various abnormalities in the park, which requires immediate knowledge of details of the warning information. As such, for a smart security type, the visitor abnormality warning information data will be classified as data of an indirect use type, and accordingly, it is required to apply for additional data and complete data aggregation before display.

By varying the data type classification rule with the business types, the display manner of business data on an interactive interface may be varied flexibly such that the visualized presentation of business data is better adapted to desired monitoring purposes.

It would be understood that the target data in the target data set may be also business data, and correspondingly, may be classified according to the above data types.

Receiving business data may comprise receiving multiple pieces of business data from the server, and classifying each piece of business data so as to classify it into a target data set with different business types.

Step 220: processing at least one of the multiple sets of target data to obtain update data for an interactive interface. The interactive interface correspond to the business type of the at least one set of target data and is configured for displaying the at least one set of target data. In some embodiments, each set of target data may have respective interactive interfaces. For example, in a scenario where the business type is divided according to purposes of the monitoring data, each set of target data with different business types may have different interactive interfaces.

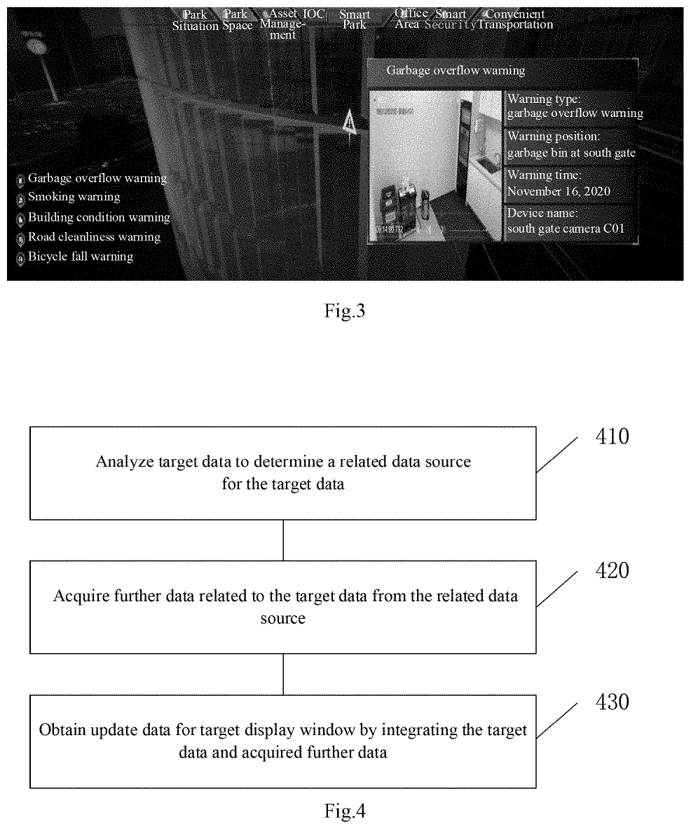

FIG. 3 shows a screen shot of an exemplary interface performing data visualization processing according to embodiments of this disclosure. The interactive interface is exemplarily configured to display business data related to a smart park. As shown by tags in the upper part of the screen shot in FIG. 3, the business data may be displayed via multiple interactive interfaces, for example including a park situation interface, a park space interface, an asset management interface, an office space interface, a smart security interface, a convenient transportation interface and so on. Each interactive interface may correspond to a business type for classifying the business data, e.g., a park situation type, a park space type, an asset management type, an office space type, a smart security type, a convenient transportation type and so on.

Alternatively, multiple sets of target data may share a same interactive interface, and each set of target data may be associated with a target display window in the interactive interface. Optionally, each set of target data may have one or more target display windows associated therewith in the interactive interface. Correspondingly, the target data may be processed to obtain update data for the target display window associated therewith in the interactive interface, and the update data may be assigned to the target display window to refresh the target display window.

When used herein, the display window may correspond to all or part of the display regions of the interactive interface, and may be used interchangeably with display region. The display window may be refreshed in response to receipt of the associated target data set from a server for example, or in response to receipt of an input instruction (e.g., an instruction to switch the target data set displayed in the display window) from the user.

Different sets of target data corresponding to different business types are processed separately so as to obtain update data for refreshing the interactive interface or target display windows in the interactive interface. Optionally, processing the target data further comprises processing different parts of a set of target data separately, wherein the different parts may correspond to sub-windows of a target display window or different target display windows.

In some embodiments, the interactive interface may comprise multiple display windows and/or switch among multiple display windows. Update of content of the interactive interface comprises refreshing one or more of the multiple display windows.

In some embodiments, the interactive interface may be configured to display a 2D UI and a 3D model. Correspondingly, the update data comprises 2D data and 3D data.

Step 230: rendering the interactive interface based on the update data to update content of the interactive interface.

In some embodiments, when a set of target data corresponds to one or more display windows of the interactive interface, the display windows to which the target data corresponds are rendered based on the obtained update data.

Since the target data sets formed according to the classification by business types are more likely to be associated with one same display object or display part of the interactive interface, updating the associated display window in the interactive interface according to the target data sets can save the storage resources and processing resources required for data visualization and improve the response speed of data visualized presentation.

In some embodiments, the update data may be obtained in many ways. FIG. 4 shows a flow chart of a method for obtaining update data according to an embodiment of this disclosure. As shown in FIG. 4, obtaining the update data for the target display window may comprise: in step 410, analyzing the target data to determine a related data source for the target data, in step 420, acquiring further data related to the target data from the related data source, and in step 430, obtaining update data for the interactive interface or the target display window by integrating the target data and acquired further data. Optionally, prior to analysis of the target data, a data type of the target data may be further determined, and in response to the target data being determined to be data of an indirect use type, the target data is analyzed to obtain further data.

Optionally, the data source may be linked using a technique of inversion of control so as to obtain further data from the data source. Exemplarily, the technique of inversion of control may be a dependency injection technique. Dependency injection is a technique in which an object receives other objects that it depends on, called dependencies. In some embodiments, when the target display window is to be refreshed, after the related data source is determined, the determined data source may be linked by means of dependency injection through a proxy. As a result, further data related to the target data may be acquired by receiving the further data injected from the determined data source through the proxy. Thereby, the transfer/injection of the update data is delegated to the proxy. Since it only requires injection of a new data source via the proxy to have the display window linked with a new data source/a new target data set rapidly, i.e., to switch to a new data source, the dependency injection enables rapid switch of data acquisition paths, thereby achieving rapid response in case of variable data sources.

For example, the display window may be arranged for displaying a warning panel for example. In a scenario where the business type comprises a park space type and a smart security type, two interactive interfaces corresponding to the business types may comprise respective display windows for displaying a park space warning panel and a smart security warning panel respectively. In this example, target data containing warning information may be associated with the park space warning panel and the smart security warning panel in the interactive interface respectively according to the corresponding business types. In this way, when the target data is determined to contain warning information after processing the data, a data source related to a respective target display window may be determined based on the business type of the target data. The data sources herein comprise a data factory for park space and a data factory for smart security. If the target data is of a park space type, it is determined that the related data source is the data factory for park space. If the target data is of a smart security type, it is determined that the related data source is the data factory for smart security. After that, different data sources may be linked for example by dependency injection through a proxy to acquire different warning data, and content of each warning panel may be refreshed based on different warning data. Alternatively, integrated data obtained from integration of the target data and warning data may be used to refresh the warning panels.

In other embodiments, multiple pieces of warning information are displayed in the interactive interface via one same display window. In such embodiments, different data sources may also be linked for example by dependency injection through a proxy in order to acquire different warning data.

Continuously referring to FIG. 3, FIG. 3 shows a display window for displaying information of equipment warnings on the right of the interactive interface. What is currently displayed in the display window is garbage overflow warning information, which comprises warning type, warning position, warning time and device name of the related monitoring device.

Other warnings that can be displayed via this display window are displayed on the left of the interactive interface, including smoking warning, building condition warning, road cleanliness warning, bicycle fall warning and so on. When the user chooses to display the smoking warning in the display window by clicking the “smoking warning” on the left of the interactive interface, the display window may be switched from being associated with/dependent on a garbage warning data source to being associated with/dependent on a smoking warning data source by means of dependency injection through a proxy. As a result, target data related to smoking warning is injected and update data corresponding to the display window is acquired.

In this way, when content of a display window is to be updated, for example upon receipt of a user instruction to refresh the window, the display window may delegate a proxy to inject further data from a corresponding data source, thereby obtaining update data.

In some embodiments, in addition to a 2D graphical display, there is also a 3D materialized display in an interactive interface. FIG. 5 is another screen shot of an exemplary interactive interface according to embodiments of this disclosure. As shown in FIG. 5, the interactive interface comprises a 2D UI (2 Dimensional User Interface) and a 3D model. The 2D UI shows graphs and pictures, e.g., a total of 12 pictures in a matrix of 6*2 shown in the upper left corner of FIG. 5, and bar charts, line charts and data tables shown on both sides of FIG. 5. The 3D model shows entity models of an office space, e.g., the 3D entity model of rooms and seats shown in the middle of FIG. 5.

In such an embodiment, during acquisition of update data for the interactive interface, the update data may comprise both 2D data and 3D data. Therefore, based on the 2D data and 3D data in the update data, the refresh of the 2D UI and 3D model may be controlled synchronously, thereby achieving the linkage of the 2D UI and 3D model and improving the effect of data visualized presentation.

In some embodiments, the rendering of the interactive interface comprises: batch-rendering objects of a same material in the 3D data. For example, in a 3D scenario, tables and chairs in the office space use one same material ball (an art resource), so they can be batch-processed in the rendering, which can reduce the number of operations (that is, Draw Calls) that CPU calls graphic programming interface GPU and command GPU to perform rendering, and thus reduce CPU consumption caused by CPU frequent calling GPU to set rendering state.

Additionally or alternatively, multiple small pictures in the 2D data may be merged into a big picture set, e.g., into one big picture, for rendering, which reduces the memory consumption. For example, the 12 pictures shown in the upper left corner of FIG. 5 may be merged into one big picture for rendering.

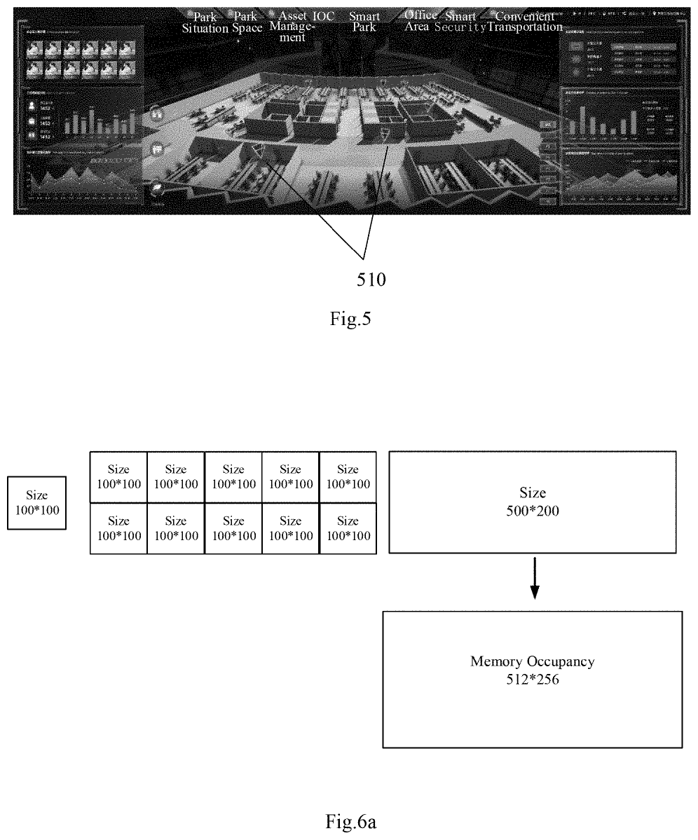

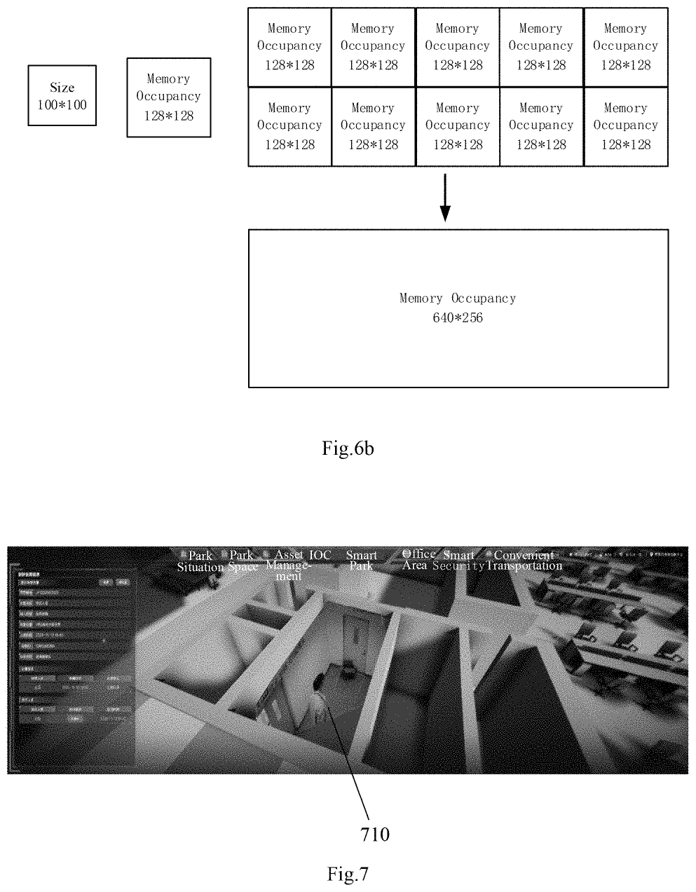

FIG. 6a shows a schematic view showing the processing of pictures during picture rendering in related arts. As shown in FIG. 6a, the original size of a small picture to be rendered is 100*100, and the number of the small pictures to be rendered is 10. According to the related arts, a memory space of 128*128 in a memory will be allocated for each small picture, where 128 is the number which is closest to 100 and is the power of 2. Therefore, the size of memory space to be allocated would be 10*128*128=163840 in order to render the 10 small pictures. If the rendering is performed according to the position relation shown in FIG. 6a, the size of the memory space occupied by the 10 small pictures would be 640*256. There would be an additional consumption of 63840 as compared with the actual size of the 10 small pictures.

FIG. 6b is a schematic view showing the processing of pictures during picture rendering according to embodiments of this disclosure. As shown in FIG. 6b, also 10 small pictures with an original size of 100*100 are to be rendered. According to embodiments of this disclosure, the multiple small pictures to be rendered are merged into a big picture first. The merging may be carried out according to the position relations of each picture required by the rendering. In the example of FIG. 6b, the 10 small pictures may be merged into a big picture with a size of 500*200 in the arrangement of two rows and five columns according to the position relations of each picture required by the rendering. Then, a memory space is allocated to the big picture obtained from the merging based on its size. For the big picture of 500*200, a memory space with only a size of 512*256=131072 needs to be allocated. In this way, the additional consumption is reduced to 31072 as compared with the actual size of the 10 small pictures. A memory space of 32768 is saved as compared with the conventional rendering in the related arts.

Additionally or alternatively, objects outside of a field of view of the target data may also be cropped, and the cropped objects/portions will not be rendered, thereby avoiding GPU consumption brought by additional rendering. The field of view refers to a visible region of an environment to be displayed in the interactive interface. This can reduce the consumption of processing resources or storage resources caused by rendering.

In some embodiments, during building of a 3D entity model, a mesh is created and assigned to a 2D object. The mesh corresponds to a shape of a specified display region in the interactive interface. 2D data is extracted from the update data as update data for the 2D object, and the specified display region is rendered based on the 2D data. Optionally, when the interactive interface is rendered based on the update data, 3D data may also be extracted from the update data as update data for the mesh, and the mesh in the 3D model may be rendered based on the 3D data. In this way, linking update of the 2D UI and 3D model is realized, and an effect of merging is achieved. The 2D object may comprise for example a video object, a picture object and a table object.

Exemplarily, a mesh corresponding to a shape of a specified display region may be created, and then assigned to a video object. The video object is associated with a mesh rendering component (Mesh Render). The mesh rendering component (Mesh Render) is associated with a material module (Material). The material module (Material) is finally associated with target 2D data (Texture 2D). In this way, the video object is finally associated with a 2D data (Texture 2D). When a video is played on the interactive interface, the 2D data (Texture 2D) of the video object will be updated continuously based on the 2D data resources of each frame of picture, thereby realizing linking update of the 2D UI and 3D model in the same interactive interface and achieving the effect of video merging.

FIG. 7 shows an interactive interface containing a 2D object and a 3D model. As shown in FIG. 7, there is a 2D object 710 (associated with a 2D data) indicating a person in the middle part of the interactive interface, and a 3D model in the other part. With a method according to the embodiments of this disclosure, the 2D object of the person can be merged with the 3D model. For example, in the rendering, by updating the 2D data associated with the 2D object, linking update of the 2D data and 3D data is realized and thus 2D pictures are displayed in a 3D scenario by video merging.

According to the embodiments of this disclosure, when the interactive interface is rendered based on the update data, by synchronously controlling the refresh of the 2D UI and the linkage of the 3D model based on the 2D data and 3D data in the update data, the effect of data visualized presentation is promoted, the timeliness of information acquisition is improved, and the speed of event processing is accelerated.

In the rendering, 3D modeling techniques may be used in combination with CAD (Computer Aided Design) vector data and GIS (Geographic Information System) information, including for example building data in the park (for example: buildings, park roads, meeting rooms, parking lots, office areas, exhibition halls) and spatial position relations, etc., to truly restore a monitored environment.

The electronic device may present a rendered data visualization picture by using various display devices, including on various media such as large Windows screens, or Android mobile terminals, or Web pages, making it easy for the user to check anytime, anywhere.

When a 3D engine is used for real-time rendering, a variety of interaction means (e.g., mouse and keyboard, touch control, gesture control) may be provided, so as to provide a user with a free interaction experience in a three-dimensional space, so that the user can check the park from a macroscopic perspective or locate an area of interest for micro-analysis.

In an example, input operations of a user may be collected and corresponding processing may be performed. The input operations of the user comprise, but are not limited to, input by mouse and keyboard, input by touch control, input by gesture control and so on.

For example, in a scenario of an interactive interface displaying an interface of a meeting room, when a user clicks a flashing region of the meeting room in a three-dimensional scene with a mouse for example on an electronic device, the electronic device may make the interactive interface jump to display a specific model of the meeting room by processing target data related to the meeting room, including, for example, linking related data sources. The user can intuitively view the equipment configuration and layout of the meeting room. In a scenario of an interactive interface displaying a parking lot interface, the user may select on the electronic device a parking space that he/she wants to park, and the electronic device may display the most convenient arrival path planned quickly on the interactive interface by processing target data related to the parking lot or convenient transportation, including, for example, linking related data sources.

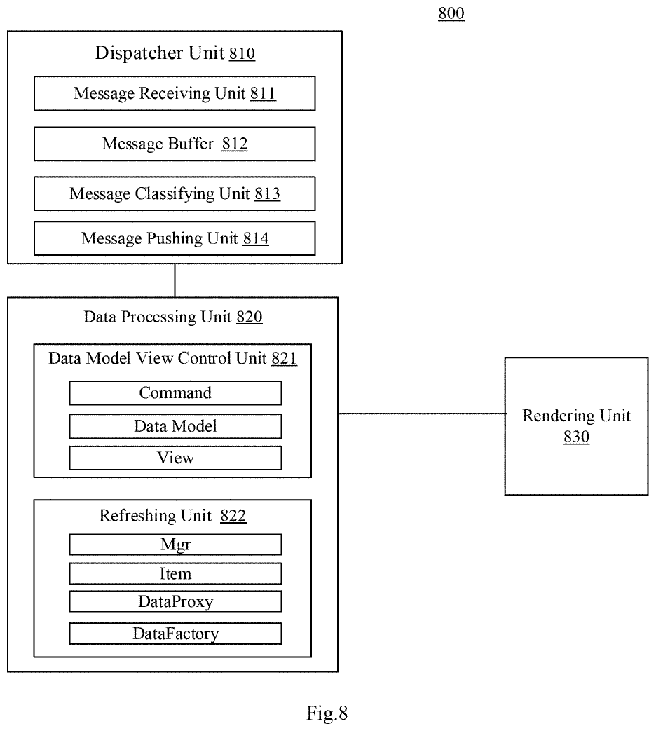

FIG. 8 shows a schematic structure view of an apparatus for data visualization according to embodiments of this disclosure. The apparatus 800 may be used as an electronic device as shown in FIG. 1 and configured to implement a method according to the embodiments of this disclosure. As shown in FIG. 8, the apparatus 800 comprises a dispatcher unit 810, a data processing unit 820 and a rendering unit 830. The dispatcher unit 810 is configured to receive business data and classify the business data according to a business type associated with the business data so as to form multiple sets of target data. Each set of target data has a corresponding business type. The data processing unit 820 is configured to receive target data from the dispatcher unit, process at least one of the multiple sets of target data to obtain update data for an interactive interface. The interactive interface correspond to the business type of the at least one set of target data and is configured to display the at least one set of target data. The update data is configured to render the interactive interface (e.g., a target display window therein) to update content of the interactive interface. The rendering unit 830 is configured to render a target display window after assigning the update data to the target display window, so as to update content of the interactive interface.

Since different business data are classified, isolation of different business data is achieved when the interactive interface is refreshed, and by processing the target data sets of the same business type, data linkage of the associated interactive interface is realized, and thus a better effect of data visualized presentation is obtained.

In some embodiments, the dispatcher unit 810 and the data processing unit 820 may be deployed in a 3D engine (e.g., unity, unreal, etc.) of the apparatus 800. The dispatcher unit 810 may connect to a specified node service (e.g., Broker service) of a cloud platform server via a preset communication protocol, and subscribe to business data of a desired type. In this way, when there is new data at the specified node service, the server will push the data to the apparatus in real time. Therefore, the apparatus can receive the latest business data in real time. Exemplarily, the preset communication protocol may be TCP (Transmission Control Protocol). Alternatively or additionally, the dispatcher unit 810 may access the server actively to acquire the business data.

Optionally, the apparatus may comprise a plurality of data processing units 820 corresponding to different business types. The dispatcher unit 810 may dispatch to data processing units 820 respective sets of target data corresponding to different business types. For example, target data belonging to a park space type may be dispatched to a park space data processing unit, and target data belonging to a smart security type may be dispatched to a smart security data processing unit.

The dispatcher unit 810 may comprise a message receiving unit 811, a message buffer 812, a message classifying unit 813 and a message pushing unit 814. The message receiving unit 811 is configured to connect to a specified node service (e.g., Broker service) at a server end, and receive from the server multiple pieces of business data to which it subscribes. The received multiple pieces of business data may be stored in the message buffer. The message buffer 812 may use a queue to buffer each piece of incoming business data, so as to avoid processing blockage and loss that may be caused by a large number of concurrent messages when there is no message buffer. The message classifying unit 813 is configured to acquire each piece of business data from the message buffer sequentially (e.g., in a first-in-first-out order). The message classifying unit is further configured to classify each piece of business data so as to form multiple sets of target data corresponding to different business types. Optionally, the message classifying unit may also reorganize data according to a predefined business orchestration rule. The message pushing unit 814 is configured to push to data processing units 820 respective sets of target data after the data has been classified.

The data processing unit 820 may comprise a data model view control (MVC) unit 821 and a refreshing unit 822.

In an example, the data processing unit 820 may comprise a plurality of MVC units 821. Each MVC unit is configured to receive a set of target data of respective type and process the set of target data. The MVC unit comprises: a control module (Control), a data model module (Model) and a view module (View). The control module receives target data from the dispatcher unit and delivers it to the data model module. The data model module further processes the target data in term of business according to a current business logic, e.g., to extract business information of interest from the target data. The business logic may be a logic defining a business connection between the target data and secondary data. Processing of target data in term of business may also mean further acquiring other secondary data for the target data according to the business type of the target data. For example, target data containing garbage overflow warning information may only carry a serial number of a garbage bin. In this scenario, business logic may define connection relationship between the serial number of the garbage bin and a position of the garbage bin as well as a person in charge of the garbage bin. Correspondingly, processing of target data in term of business according to business logic may comprise: acquiring other secondary data such as the position of the garbage bin, the person in charge of the garbage bin and so on based on the serial number of the garbage bin. The view module (View) may manage one or more refreshing units and configured to call one or more refreshing units to process the target data after it is processed in term of business so as to obtain update data.

The refreshing unit 822 may comprise: a display window refreshing module, a display window module, a proxy module and a data source module. The display window refreshing module is configured to control the entire display refreshing process according to a refreshing logic. The display refreshing process comprises generating corresponding update data based on the target data processed in term of business, and assigning the update data to the display window module. The display window module corresponds to a display window of the interactive interface and is configured to assign values to the display window based on the update data so as to control the refresh of the display window. The proxy module is configured to connect to the data source module related to the target display window. The data source module is configured to receive and store the obtained target data, and the target data has an associated target display window in the interactive interface.

In some embodiments, the data processing unit 820 may comprise a plurality of refreshing units 822. Each refreshing unit is configured to process different portions of a set of target data. For example, different portions of a set of target data may comprise portions corresponding to 2D data and 3D data respectively. Correspondingly, the data processing unit may comprise refreshing units for processing 2D data and 3D data respectively.

The refreshing unit 822 may comprise a plurality of display window modules and a plurality of data source modules, which correspond to different display windows on the interactive interface. A display window refreshing module may manage a plurality of display window modules and hold a proxy module. The proxy module may link to a specific data source module by means of dependency injection. The view module will call a refreshing logic of the display window refreshing module upon receipt of the target data. The display window refreshing module may determine a target display window to be refreshed based on the refreshing logic and the target data. After that, the display window refreshing module only needs to control the proxy module to link to a new data source module related to the target display window by utilizing dependency injection in order to obtain the update data for the target display window. The dependency injection method enables a rapid switch of the data acquisition paths through switch of the data sources (where only injection from a new data source module is required), thereby meeting the needs of immediate response in case of variable data sources.

For example, when display content of a display window A in an interactive interface needs to be updated based on target data, the display window refreshing module may first control the data source module to receive and store the target data; secondly, the display window refreshing module may control the proxy module to connect to the data source module so as to acquire update data for the display window A; thirdly, the display window refreshing module may control the display window module to assign the update data to the display window A so as to refresh the display window A.

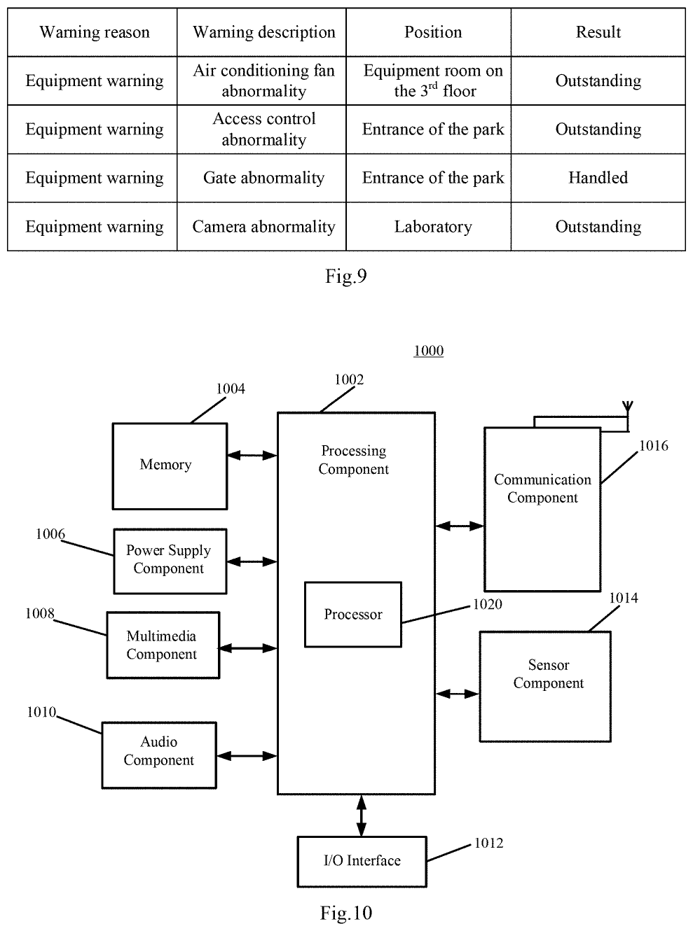

FIG. 9 exemplarily shows a display effect of warning business data according to embodiments of this disclosure. As shown in FIG. 9, a table has four display windows for displaying equipment warnings. For example, the equipment management business type has a display window for warning display, and is designed to display the following warning contents in four columns: warning reason, warning description, location and result; and the security business type also has the need of warning display, and is also designed to display the warning contents of warning reason, warning description, location and result in four columns via a display window. In these display windows, the layout of the contents to be displayed is consistent, e.g., the number of columns of the contents is consistent. The display windows may be managed by one same display window refreshing module and may correspond to one same proxy module. The data source modules may receive and store different warning data corresponding to the equipment management business type or the security business type. When displaying the interactive interface corresponding to the equipment management business type or the security business type, the display window refreshing module may control the proxy module to link to a data source module storing target data of a corresponding business type in a manner of dependency injection so as to acquire corresponding update data. The display window module uses the update data to assign values to the corresponding display window so as to display corresponding contents, e.g., warning contents. Upon switching the warning contents to be displayed, it is only required to control the proxy module to switch to a corresponding data source module. According to this embodiment, when the layout of contents to be displayed in the display window is consistent, the display window refreshing module and the display window module may be reused. That is, such contents may share the display window refreshing module and the display window module. The display window for displaying such contents may be the same window or different windows.

The operation of a system according to embodiments of this disclosure will be described below in combination with an exemplary business scenario. The system comprises a smart device, a server and an electronic device.

Firstly, the server starts up, and creates a Broker node for a message queue MQ for collection and transfer of messages.

Various smart devices will connect to the Broker node of the server for reporting/publishing messages. The messages may refer to monitoring data in this context. In some embodiments, the smart device may act for example as a publisher to define topics to which a subscriber may subscribe. Exemplarily, the monitoring data may be in a form of: {topic=“WarningTip”, eventTypeId=0, deviceId=0x1101}.

After the startup of the electronic device, the message receiving unit of the dispatcher unit will connect to the Broker node of MQ and subscribe to a corresponding topic ({topic=“WarningTip”}). The server will send to the electronic device all monitoring data that the smart device publishes to the topic to which the electronic device subscribes. Additionally or alternatively, the electronic device may also make a subscription by defining a restriction for the monitoring data of its interest. In this case, the server will not transfer the monitoring data to the electronic device until properties of the monitoring data in the message queue match with the restriction defined by the electronic device.

Now, if a certain smart device detects an air conditioning system failure, the smart device will report the warning information (carrying related information such as {topic=“WarningTip”, eventTypeId=0, deviceId=0x1101} when making the report) to the Broker node of the message queue MQ of the server, and upon receipt of the message, the Broker node will broadcast it to the electronic device subscribing to this topic.

After the message receiving unit receives the business data, which is real-time warning information here, it will put the real-time warning information to the message buffer and queue up for processing. When the warning information is taken out of the message buffer, the warning information is transferred to the message classifying unit. The message classifying unit matches an eventTypeId property carried by the warning information with a (local) business rule and finds that the warning information belongs to a business type related to park space, and thus classifies it into a target data set corresponding to park space. As such, it is determined that the target data set belongs to a park space data processing unit. Since the business data contains equipment abnormality warning information and such data is determined to be of an indirect use type according to the business orchestration rule, aggregation/reorganization is further performed for the data. For example, we may add {themeType=SmartPark.ParkSpace, warningType=“deviceWarning”} to the warning information and then push it to the park space data processing unit. The park space data processing unit is responsible for processing the target data set.

The MVC unit of the park space data processing unit comprises ParkSpaceView (i.e., a park space view module), ParkSpaceModel (i.e., a park space data model module) and ParkSpaceControl (i.e., a park space control module). Upon receipt of the target data sent from the message dispatcher unit, ParkSpaceControl delivers it to ParkSpaceModel. After buffering the data, ParkSpaceModel splits off information such as warningType=“deviceWarning”, deviceId=0x1101 therefrom and delivers it to ParkSpaceView. ParkSpaceView manages a plurality of display window refreshing modules, e.g., a warning information panel refreshing module corresponding to a warning information panel, a 3D warning spot refreshing module corresponding to a 3D warning spot and so on.

In an example, based on information such as warningType=“deviceWarning”, deviceld=0x1101 that has been split off, ParkSpaceView determines that the target display window associated with the target data is a warning information panel, and therefore selects a warning information panel refreshing module to process the target data.

The warning information panel refreshing module mainly comprises WarningInfoMgr (i.e., warning information refreshing module), WarningInfoItem (i.e., warning information display window module), WarningInfoDataFactory (i.e., warning information data factory module) and so on. The ParkSpaceView module delivers the received target data to WarningInfoMgr. WarningInfoMgr parses these data as being of a warning type and sets for example http restful interface address by a proxy (a proxy module) according to a profile (the profile may be used to configure data source interfaces of different businesses), so that WarninglnfoDataFactory may acquire more detailed information List<WarninglnfoData> of the warning data, and then call back to WarningInfoMgr by means of, for example, delegation. WarningInfoMgr triggers RefreshListData logic and pushes each piece of WarninglnfoData to a specific WarningInfoItem so as to perform assignment. After being assigned by WarningInfoItem, the warning information panel is refreshed, thereby realizing content update of the park space interactive interface. As shown in FIG. 3 above, a warning interface of garbage overflow is displayed on the right of the interactive interface.

Additionally or alternatively, based on information such as warningType=“deviceWarning”, deviceId=0x1101 that has been split off, ParkSpaceView may further determine that another target display window associated with the target data is a 3D warning spot display window, and therefore selects a 3D warning spot display window refreshing module to process the target data.

The 3D warning spot display window refreshing module may comprises Warning3DMgr (i.e., 3D warning spot refreshing module), Warning3DItem (i.e., 3D warning spot display window module) and Warning3DDataFactory (3D warning spot data source module) and so on. ParkSpaceView delivers the received target data to Warning3DMgr, which parses these data as being of a warning type and then sets http interface address via a proxy (a proxy module) so that Warning3DDataFactory may acquire more detailed information List<Warning3DData> of the warning data, and then call back to Warning3DMgr by means of delegation. Warning3DMgr triggers RefreshListData logic, and refreshes the interactive interface by adding a plurality of 3D warning spot objects of a corresponding type in a corresponding position of the interactive interface. As shown in FIG. 5, the 3D warning spot object 510 may be presented as a 3D conical object in the 3D model.

In some embodiments, a 3D warning spot object may be clicked. In response to the click, monitoring picture information carried in the Warning3DData associated with the 3D warning spot object may be retrieved, and the monitoring picture may be displayed in a 3D scene by means of video merging.

In some embodiments, a 3D object may link with a 2D object, e.g., a corresponding row of data, displayed in the 2D UI. When a certain 3D object is clicked, selection logic of this row of data will be executed such that this row of data in the 2D UI becomes selected.

FIG. 10 shows a schematic structure view of a computing device 1000 for implementing the solution according to embodiments of this disclosure. The computing device 1000 may be configured to carry out the method according to the embodiments of this disclosure and/or implement the electronic device and apparatus according to the embodiments of this disclosure. The computing device 1000 may include one or more of: a processing component 1002, a memory 1004, a power supply component 1006, a multimedia component 1008, an audio component 1010, an input/output (I/O) interface 1012, a sensor component 1014, and a communication component 1016.

The processing component 1002 generally controls the overall operations of the computing device 1000, such as operations associated with display, telephone calls, data communications, camera operations, and recording operations. The processing component 1002 may comprise one or more processors 1020 to execute instructions to complete all or part of the steps of the method according to the embodiments of this disclosure. Besides, the processing component 1002 may comprise one or more modules to facilitate interaction between the processing component 1002 and other components. For example, the processing component 1002 may comprise a multimedia module to facilitate interaction between the multimedia component 1008 and the processing component 1002.

The memory 1004 is configured to store various types of data to support the operation of the computing device 1000. Examples of these data include instructions of any application or method for operating on the computing device 1000, contact data, phone book data, messages, pictures, videos, etc. The memory 1004 may be implemented by any type of a volatile or non-volatile storage device or a combination thereof, such as static random access memory (SRAM), electrically erasable programmable read-only memory (EEPROM), erasable and programmable read-only memory (EPROM), programmable read-only memory (PROM), read-only memory (ROM), magnetic memory, flash memory, magnetic disk or optical disk.

The power supply component 1006 provides electric power for each component of the computing device 1000. The power supply component 1006 may comprise a power management system, one or more power supplies, and other components associated with the generation, management, and distribution of electric power for the computing device 1000.

The multimedia component 1008 comprises a screen that provides an output interface between the computing device 1000 and the user. In some embodiments, the screen may comprise a liquid crystal display (LCD) and a touch panel (TP). If the screen comprises a touch panel, it may be implemented as a touch panel for receiving input signals from the user. The touch panel comprises one or more touch sensors for sensing touch, slide, and gestures on the touch panel. The touch sensor may not only sense the boundary of a touch or slide action, but also detect the duration and pressure related to the touch or slide operation. In some embodiments, the multimedia component 1008 comprises a front camera and/or a rear camera. When the device 1000 is in an operation mode, e.g., a photographing mode or a video mode, the front camera and/or the rear camera may receive multimedia data from the outside. Each of the front camera and rear camera may be a fixed optical lens system or have a focal length and optical zooming capacities.

The audio component 1010 is configured to output and/or input audio signals. For example, the audio component 1010 comprises a microphone (MIC). When the computing device 1000 is in an operation mode, e.g., a calling mode, a recording mode and a voice recognizing mode, the microphone is configured to receive audio signals from the outside. The received audio signal may be further stored in the memory 1004 or transmitted via the communication component 1016. In some embodiments, the audio component 1010 further comprises a loudspeaker for outputting audio signals.

The I/O interface 1012 provides an interactive interface between the processing component 1002 and a peripheral interface module. The peripheral interface module may be keyboards, click wheels, buttons and so on. The buttons may comprise but are not limited to: home button, volume button, start button and lock button.

The sensor component 1014 comprises one or more sensors for providing state evaluations for the computing device 1000 from every aspect. For example, the sensor component 1014 may detect the on/off state of the device 1000 and the relative positioning of the components, for example, the components being a display and a keypad of the computing device 1000, and the sensor component 1014 may also detect changes in the position of the computing device 1000 or a component of the computing device 1000, the presence or absence of contact between the user and the computing device 1000, the orientation or acceleration/deceleration of the computing device 1000, and changes in the temperature of the computing device 1000. The sensor component 1014 may comprise a proximity sensor configured to detect the presence of objects nearby when there is no physical contact. The sensor component 1014 may further comprise a light sensor, e.g., a CMOS or CCD image sensor for use in imaging applications. In some embodiments, the sensor component 1014 may further comprise an acceleration sensor, a gyroscope sensor, a magnetic sensor, a pressure sensor or a temperature sensor.

The communication component 1016 is configured to facilitate wired or wireless communication between the computing device 1000 and other devices. The computing device 1000 may access a wireless network based on a communication standard, e.g., WiFi, 2G or 3G, or a combination thereof. In an exemplary embodiment, the communication component 1016 receives broadcast signals from an external broadcast management system or broads related information via a broadcast channel. In an exemplary embodiment, the communication component 1016 further comprises a near field communication (NFC) module to facilitate short-range communication. For example, the NFC module may be implemented based on radio frequency identification (RFID) technology, infrared data association (IrDA) technology, ultra-wideband (UWB) technology, Bluetooth (BT) technology and other technologies.

In an exemplary embodiment, the computing device 1000 may be implemented by one or more application-specific integrated circuits (ASIC), digital signal processors (DSP), digital signal processing devices (DSPD), programmable logic devices (PLD), field programmable gate arrays (FPGA), controllers, microcontrollers, microprocessors, or other electronic components so as to perform the data visualization method according to the embodiments of this disclosure.

In an exemplary embodiment, a non-transitory computer-readable storage medium containing instructions is further provided, for example a memory 1004 containing instructions. The instruction may be executed by the processor 1020 of the computing device 1000 so as to perform the method according to the embodiments of this disclosure. For example, the non-transitory computer-readable storage medium may be ROM, random access memory (RAM), CD-ROM, magnetic tape, floppy disk, optical data storage device, etc.

Possible systematic architectures, functions and operations that may be implemented by the system, method and computer program product according to various embodiments of this disclosure are shown in the form of flow charts and diagrams. In this regard, each box in the flow charts or the diagrams can represent a module, a program segment or a portion of codes, and the module, the program segment or the portion of codes comprises one or more executable instructions for implementing a prescribed logic function. It should be further noted that in some implementations as alternatives, functions indicated in the boxes may also be performed in a sequence different from that indicated in the drawings. For example, two consecutive boxes may actually be executed substantially concurrently, and sometimes they may also be executed in an opposite sequence, and this depends on the functions involved. It should be further noted that each box in the diagrams and/or the flow charts and a combination of the boxes in the diagrams and/or the flow charts may be implemented by means of a dedicated hardware-based system for performing a prescribed function or operation, or by means of a combination of dedicated hardware and computer instructions.

Units or modules involved and described in the embodiments of this disclosure may be implemented by means of software or by means of hardware. Components like a dispatcher unit, a data processing unit and a rendering unit may comprise an electronic circuit or a combination of an electronic circuit and a control program operating these components according to the concept described herein.

Although optional embodiments of this disclosure have been described, those skilled in the art may make further variations and modifications of these embodiments once they know the basic inventive concept. Therefore, the appended claims should be construed as including these optional embodiments and all variations and modifications falling within the scopes of this disclosure.

Obviously, those skilled in the art can make various modifications and variations to this disclosure without departing from spirits and scopes of this disclosure. Thus if these modifications and variations to this disclosure fall within the scopes of the claims of this disclosure and the equivalent techniques thereof, this disclosure is intended to include them too.

1. A method for data visualization, comprising:
receiving business data and classifying the business data according to a business type associated with the business data so as to form multiple sets of target data;
processing at least one set of target data of the multiple sets of target data to obtain update data for an interactive interface, the interactive interface corresponding to the business type of the at least one set of target data and for displaying the at least one set of target data; and
rendering the interactive interface based on the update data to update content of the interactive interface.

2. The method according to claim 1,
wherein the at least one set of target data is associated with a target display window in the interactive interface,
wherein said processing at least one set of the multiple sets of target data to obtain update data for the interactive interface comprises processing the at least one set of target data to obtain update data for the target display window in the interactive interface, and
wherein said rendering the interactive interface based on the update data comprises assigning the update data to the target display window to refresh the target display window.

3. The method according to claim 1, wherein said processing at least one set of the multiple sets of target data to obtain update data for the interactive interface comprises:
analyzing target data in the at least one set of target data to determine a related data source for the target data,
acquiring further data related to the target data from the related data source, and
obtaining the update data for the interactive interface by integrating the target data and acquired further data.

4. The method according to claim 3, wherein said acquiring further data related to the target data from the related data source comprises:
in response to determination of the related data source, linking the related data source by utilizing dependency injection through a proxy, and receiving further data injected from the related data source through the proxy so as to acquire the further data related to the target data.

5. The method according to claim 1,
wherein the interactive interface displays a two dimensional (2D) user interface and a three dimensional (3D) model, and
wherein said processing at least one set of the multiple sets of target data to obtain update data for an interface comprises obtaining 2D data for updating the 2D user interface and 3D data for updating the 3D model.

6. The method according to claim 5, wherein said rendering the interactive interface based on the update data comprises at least one of:
batch-rendering objects of a same material in the 3D data;
merging multiple pictures in the 2D data into one picture before rendering; or
cropping an object outside a field of view in the 3D data before rendering.

7. The method according to claim 5, wherein a mesh is created and assigned to a 2D object during building of the 3D model, the mesh corresponding to a shape of a specified display region of the 2D user interface, and wherein said rendering the interactive interface based on the update data comprises:
extracting 2D data from the update data as update data for the 2D object; and
rendering the specified display region based on the 2D data.

8. The method according to claim 1,
wherein the business data is generated based on monitoring data for an environment produced by a smart device, and the business type is divided according to characteristics of the monitoring data,
wherein the characteristics comprise at least one of monitoring objects for which the monitoring data is generated or intended purposes of the monitoring data.

9. The method according to claim 1, wherein said receiving business data comprises:
determining a data type of the received business data;
in response to a determination that received business data is data of an indirect use type, using the received business data as primary business data, and extracting index information from the primary business data;
accessing a related data source according to the index information to acquire secondary business data; and
aggregating the primary business data and the secondary business data to generate aggregated business data.

10. An electronic device, comprising a memory, a processor and a computer program stored on the memory and executable on the processor, wherein the processor implements the method according to claim 1 when executing the computer program.

11. The electronic device according to claim 10,
wherein the at least one set of target data is associated with a target display window in the interactive interface,
wherein said processing at least one set of the multiple sets of target data to obtain update data for an interface comprises processing the at least one set of target data to obtain update data for the target display window in the interactive interface, and
wherein said rendering the interactive interface based on the update data comprises assigning the update data to the target display window to refresh the target display window.

12. The electronic device according to claim 11, wherein said processing at least one set of the multiple sets of target data to obtain update data for an interface comprises:
analyzing target data in the at least one set of target data to determine a related data source for the target data;
acquiring further data related to the target data from the related data source; and
obtaining update data for the interactive interface by integrating the target data and acquired further data.

13. The electronic device according to claim 12, wherein said acquiring further data related to the target data from the related data source comprises:
in response to determination of the related data source, linking the related data source by utilizing dependency injection through a proxy; and
receiving further data injected from the related data source through the proxy so as to acquire the further data related to the target data.

14. The electronic device according to claim 10,
wherein the interactive interface displays a 2D user interface and a 3D model, and
wherein said processing at least one set of the multiple sets of target data to obtain update data for an interface comprises obtaining 2D data for updating the 2D user interface and 3D data for updating the 3D model.

15. The electronic device according to claim 14, wherein said rendering the interactive interface based on the update data comprises at least one of:
batch-rendering objects of a same material in the 3D data;
merging multiple pictures in the 2D data into one picture before rendering; or
cropping an object outside a field of view in the 3D data before rendering.

16. The electronic device according to claim 14, wherein a mesh is created and assigned to a 2D object during building of the 3D model, the mesh corresponding to a shape of a specified display region of the 2D user interface, and wherein said rendering the interactive interface based on the update data comprises:
extracting 2D data from the update data as update data for the 2D object; and
rendering the specified display region based on the 2D data.

17. The electronic device according to claim 10, wherein said receiving business data comprises:
determining a data type of received business data;
in response to a determination that the received business data is data of an indirect use type, using the received business data as primary business data, and extracting index information from the primary business data;
accessing a related data source according to the index information to acquire secondary business data; and
aggregating the primary business data and the secondary business data to generate aggregated business data.

18. A non-transitory computer-readable storage medium, having a computer program stored thereon, wherein the computer program, when executed by a processor, implements the method according to claim 1.

19. An apparatus for data visualization, comprising:
a dispatcher unit configured to receive business data and classify the business data according to a business type associated with the business data so as to form multiple sets of target data;
a data processor unit configured to receive target data from the dispatcher unit, and process at least one set of target data of the multiple sets of target data to obtain update data for an interactive interface, the interactive interface corresponding to the business type of the at least one set of target data and configured to display the at least one set of target data; and
a renderer unit configured to render the interactive interface based on the update data to realize content update of the interactive interface.

20. A system for data visualization, comprising:
a smart device configured to collect monitoring data;
a server configured to receive the monitoring data from the smart device and generating business data based on the monitoring data; and
an electronic device configured to receive business data from the server and classifying the business data according to a business type associated with the business data so as to form multiple sets of target data, configured to process at least one set of target data of the multiple sets of target data to obtain update data for an interactive interface, the interactive interface corresponding to the business type of the at least one set of target data and configured for displaying the at least one set of target data, and configured to render the interactive interface based on the update data to update content of the interactive interface.
